(19) United States
(12) Patent Application Publication
(10) Pub. No.: US 2025/0076188 A1
(43) Pub. Date: Mar. 6, 2025

(54) METHOD FOR EVALUATING FINGERPRINT RESISTANCE, LAMINATE, PRODUCTION METHOD THEREOF, AND DISPLAY DEVICE

(71) Applicant: Japan Aviation Electronics Industry, Ltd., Tokyo (JP)

(72) Inventors: Shingo TAKATA, Tokyo (JP); Toshihiro NINOKATA, Tokyo (JP); Akira IWASAKI, Tokyo (JP)

(21) Appl. No.: 18/726,678

(22) PCT Filed: Feb. 8, 2023
(86) PCT No.: PCT/JP2023/004257

§ 371 Date: Jul. 3, 2024

(30) Foreign Application Priority Data
Feb. 9, 2022 (JP) 2022-018975
Feb. 9, 2022 (JP) 2022-018976
Feb. 9, 2022 (JP) 2022-018977
Feb. 7, 2023 (JP) 2023-017102
Feb. 7, 2023 (JP) 2023-017104
Feb. 7, 2023 (JP) 2023-017105

(51) Int. Cl. G01N 21/27; G01N 21/25; G01N 21/41

(52) U.S. Cl. CPC G01N 21/27; G01N 21/251; G01N 21/41

(57) ABSTRACT

Provided are a fingerprint resistance evaluation method based on wiping property applicable to in-vehicle display devices, a laminate with excellent fingerprint resistance that satisfies the evaluation criteria according to the above evaluation method, the production method thereof, and a display device having the laminate. A method for evaluating fingerprint resistance of a surface of an object, including using a measured value difference ΔL*(θ) between the portion to which the artificial fingerprint liquid is transferred and once wiped off, and the portion to which the artificial fingerprint liquid is not transferred on the surface of the object, obtained from formula (1) defined in the specification, with a variable angle colorimeter. A laminate having a surface with ΔL*(θ) of 0.1 or less, a method for producing the same, and a display device having the laminate.

### TECHNICAL FIELD

The present invention relates to a method for evaluating fingerprint resistance, a laminate, a production method thereof, and a display device.

### BACKGROUND ART

In recent years, there have been an increasing number of opportunities to operate various electronic devices by actually touching a display device such as a touch panel display with a finger. Such display devices are required to have fingerprint resistance in order to prevent deterioration of display image performance due to fingerprints.

In addition, various treatments such as anti-glare treatment, low-reflection treatment, and anti-fingerprint treatment are typically applied to the surface of in-vehicle display devices in order to control the effects of reflections caused by sunlight and the like, but such processing may make fingerprints more noticeable and reduce fingerprint resistance.

As a method to evaluate fingerprint resistance, Patent Literature 1 discloses a technique with the lightness L* measured by a simultaneous photometric spectrophotometer specified by the CIE1976L*a*b* display system before and after applying a diluted oleic acid solution to the surface of the object to be evaluated.

### CITATION LIST

### Patent Literature

Patent Literature 1: Japanese Unexamined Patent Application Publication No. 2020-34416

### SUMMARY OF INVENTION

### Technical Problem

When a display device is used in a vehicle, such as an in-vehicle display device, the evaluation results obtained by the evaluation method described in Patent Literature 1 may deviate from the results of sensory evaluation by humans inside the vehicle, and the evaluation method itself may not be able to reproduce the actual environment inside the vehicle. Herein, if there are fingerprints or the like on the display screen, users typically wipe the display screen before use, and thus it is also significantly important to develop a method for evaluating fingerprint resistance after wiping the surface of an in-vehicle display device.

Therefore, an object of the present invention is to provide a method for evaluating fingerprint resistance based on wiping property applicable to in-vehicle display devices, a laminate with excellent fingerprint resistance that satisfies the evaluation criteria according to the evaluation method, a method for producing the same, and a display device having the laminate described above.

### Solution to Problem

The present invention provides a method for evaluating fingerprint resistance, a laminate, a method for producing the same, and a display device, having the following configurations [1] to [12].

[1]A method for evaluating fingerprint resistance of a surface of an object, comprising using a measured value difference ΔL*(θ) between a portion to which an artificial fingerprint liquid is transferred and once wiped off, and a portion to which an artificial fingerprint liquid is not transferred on a surface of the object, obtained from formula (1) below with a variable angle colorimeter:

$$Δ L * ( θ ) = L * of wipping portion after transfer of artificial fingerprint liquid - L * of artificial fingerprint liquid non - transfer portion \qquad Formula ( 1 )$$

wherein a light incidence angle is −70° with respect to a normal to a surface of the object, and a measurement angle is −5° with respect to a normal to a surface of the object.
   [2] The evaluation method according to [1], wherein a method of transferring an artificial fingerprint liquid is a method including adhering the artificial fingerprint liquid to a base material for transfer by a spin coating method to prepare a transfer foil with a haze value of 7±2%, pressing a pseudo finger against the transfer foil with a load of 60 N, and then pressing the pseudo finger against a surface of the object for 2 seconds with a load of 60 N.
   [3] The evaluation method according to [1] or [2], comprising further using an amount of squalene adhered to a surface of the object when evaluating fingerprint resistance of the surface of the object.
   [4]A laminate comprising a surface having a measured value difference ΔL*(θ) between a portion to which an artificial fingerprint liquid is transferred and once wiped off, and a portion to which an artificial fingerprint liquid is not transferred, obtained from formula (1) below with a variable angle colorimeter, of 0.1 or less,

$$Δ L * ( θ ) = L * of wipping portion after transfer of artificial fingerprint liquid - L * of artificial fingerprint liquid non - transfer portion \qquad Formula ( 1 )$$

wherein a light incidence angle is −70° with respect to a normal to a surface of a measurement object, and a measurement angle is −5° with respect to a normal to the surface of the measurement object.
   [5] The laminate according to [4], comprising a base material, a predetermined layer disposed on the base material, and an outermost layer disposed on the predetermined layer, wherein
the predetermined layer includes a first predetermined layer on a side of the base material and a second predetermined layer on a side of the outermost layer, and
a refractive index of the first predetermined layer is 2.00 or less.
   [6] The laminate according to [4] or [5], comprising a base material, a predetermined layer disposed on the base material, and an outermost layer disposed on the predetermined layer, wherein
the predetermined layer includes a first predetermined layer on a side of the base material and a second predetermined layer on a side of the outermost layer, and
a refractive index of the second predetermined layer is 1.43 or more and 1.49 or less.
   [7] The laminate according to any one of [4] to [6], wherein
on the surface of the laminate, angular dependence of ΔL*(θ) at the light incidence angle of −70° indicates a negative peak in a specular reflection region and a positive peak at an angle other than the specular reflection region, and
an amount of squalene adhered on the surface of the laminate after the transfer of the artificial fingerprint liquid and before wiping is less than 40 μg.
   [8] The laminate according to any one of [4] to [6], wherein on the surface of the laminate, angular dependence of ΔL*(θ) at the light incidence angle of −70° does not indicate a positive peak at angles other than a specular reflection region.
   [9] The laminate according to [8], wherein an outermost layer is disposed on a second predetermined layer, and a distance from the surface of the outermost layer to the second predetermined layer is 60 nm or less.
   [10] The laminate according to any one of [4] to [9], wherein a method of transferring the artificial fingerprint liquid is a method including adhering the artificial fingerprint liquid to a base material for transfer by a spin coating method to prepare a transfer foil with a haze value of 7±2%, pressing a pseudo finger against the transfer foil with a load of 60 N, and pressing the pseudo finger against the surface of the laminate for 2 seconds with a load of 60 N.
   [11]A display device comprising the laminate according to any one of [4] to [10].
   [12]A method for producing a laminate, wherein the laminate is produced so that on a surface of the laminate, a measured value difference ΔL*(θ) between a portion to which an artificial fingerprint liquid is transferred and once wiped off, and a portion to which an artificial fingerprint liquid is not transferred, obtained from formula (1) below with a variable angle colorimeter is 0.1 or less,

$$Δ L * ( θ ) = L * of wipping portion after transfer of artificial fingerprint liquid - L * of artificial fingerprint liquid non - transfer portion , and \qquad Formula ( 1 )$$

a light incidence angle is −70° with respect to a normal to a surface of a measurement object, and a measurement angle is −5° with respect to a normal to the surface of the measurement object.

### Advantageous Effects of Invention

The present invention can provide a method for evaluating fingerprint resistance based on wiping property applicable to in-vehicle display devices, a laminate with excellent fingerprint resistance that satisfies the evaluation criteria according to the evaluation method, a production method thereof, and a display device having the laminate.

### BRIEF DESCRIPTION OF DRAWINGS

FIG. 1A is a schematic plan view showing how sunlight is irradiated onto a display device from outside the vehicle directly or through glass or the like;

FIG. 1B is a schematic view showing the incidence angle and measurement angle of sunlight on the display device;

FIG. 2 is a graph showing an example of the correlation between the ΔL*(θ) value and the sensory evaluation results by the users;

FIG. 3 is a graph showing an example of the correlation between ΔL*(SCI) values and sensory evaluation results by users;

FIG. 4 is a graph showing an example of the angular dependence of ΔL*(θ) at a light incidence angle of −70° in the laminate after artificial fingerprint liquid transfer and before wiping operation; and

FIG. 5 is a graph showing another example of the angular dependence of ΔL*(θ) at a light incidence angle of −70° in the laminate after artificial fingerprint liquid transfer and before wiping operation.

### DESCRIPTION OF EMBODIMENTS

In the evaluation method described in Patent Literature 1, the fingerprint resistance of the object to be evaluated is evaluated by using the lightness L*, as an index, defined by the CIE1976L*a*b* display system on the surface of the object to be evaluated before and after applying the diluted oleic acid solution. Further, in Patent Literature 1, a simultaneous photometric spectrophotometer is used to measure the lightness L*, and further, in order to evaluate the accuracy of the evaluation method, sensory evaluation under a three-wavelength fluorescent lamp is used. However, under these conditions, the incidence angle and measurement angle are not determined, and thus it is not possible to evaluate the fingerprint resistance of the display device under the environment inside the vehicle, and the evaluation results obtained by the method of Patent Literature 1 and the actual sensory evaluation results in the vehicle may have diverged.

Further, in the evaluation method described in Patent Literature 1, a diluted oleic-acid solution prepared by dissolving oleic acid in ethanol is used to evaluate fingerprint resistance, but with the diluted solution, the state of adhesion to the display device may differ from the actual fingerprint. In particular, for a display device equipped with an oil-repellent coating, it has sometimes been difficult to accurately evaluate fingerprint resistance due to droplet repelling of the diluted oleic acid solution.

Further, in the evaluation method described in Patent Literature 1, fingerprint resistance was evaluated by adhering diluted oleic acid solution with a finger cot, but with this method, there was a case in which it was not possible to adhere a pseudo-fingerprint with good reproducibility.

On the other hand, in the fingerprint resistance evaluation method of the present invention, similar to the method described in Patent Literature 1, the lightness L* defined by the CIE1976L*a*b* display system is used, and the measuring device used is not a simultaneous photometric spectrophotometer, but a variable angle colorimeter that applies a specific light incidence angle and measurement angle. As described above, the present invention assumes the environment inside a vehicle, takes into account the position of the sun, the position of the display device, and the viewpoint of the user such as the driver, and uses, as an index of fingerprint resistance, the amount of change in the variable angle lightness L*(θ) before and after the artificial fingerprint liquid based on wiping property is adhered when the measurement conditions of the variable angle colorimeter are set to an incidence angle of −70° and a measurement angle of −5°. Therefore, the present invention can provide a highly accurate method for evaluating fingerprint resistance (fingerprint conspicuousness), the method allowing to provide evaluation results equivalent to the sensory evaluation results in an actual vehicle.

Further, in the present invention, for example, a conventionally known artificial fingerprint liquid can be used for evaluation instead of the diluted oleic acid solution. For some artificial fingerprint liquids, solid components such as dust and sebum are taken into account, and using such an artificial fingerprint liquid can lead to evaluations that take into account actual fingerprint adherence more accurately than with the diluted oleic acid solution. In addition, using an artificial fingerprint liquid containing such a solid component allows the fingerprint resistance evaluation method of the present invention to be easily applied to a display device equipped with an oil-repellent coating.

Further, in the present invention, fingerprint resistance can be evaluated in a state after the artificial fingerprint liquid is attached and once wiping off by using a specific transfer method, and thus evaluation can be performed under conditions that more closely reflect the actual vehicle environment.

The present invention will be explained in detail below. However, the present invention is not limited to the following embodiments. Further, in order to clarify the explanation, the following description and drawings are simplified as appropriate. In the following explanation, “to” indicating a numerical range means that the numerical values written before and after it are included as a lower limit value and an upper limit value. In addition, (meth)acrylic acid means either one or both of methacrylic acid and acrylic acid.

### <Method for Evaluating Fingerprint Resistance>

The fingerprint resistance evaluation method of the present invention (hereinafter sometimes referred to as the present evaluation method) is a method for evaluating the fingerprint resistance after wiping the surface of an object (measurement object), and uses a measured value difference ΔL*(0) between the portion to which the artificial fingerprint liquid is transferred and then once wiped off, and the portion to which the artificial fingerprint liquid is not transferred on the surface of the object, obtained from the following formula (1) with a variable angle colorimeter. Various materials can be used for wiping the surface of the object, and for example, Scotch Brite No. 5000 (trade name, manufactured by 3M Japan Limited) can be used.

$$Δ L * ( θ ) = L * of wipping portion after transfer of artificial fingerprint liquid - L * of the artificial fingerprint liquid non - transfer portion , \qquad Formula ( 1 )$$

in which the light incidence angle is −70° relative to the normal to the surface of the object, and the measurement angle is −5° relative to the normal to the surface of the object.

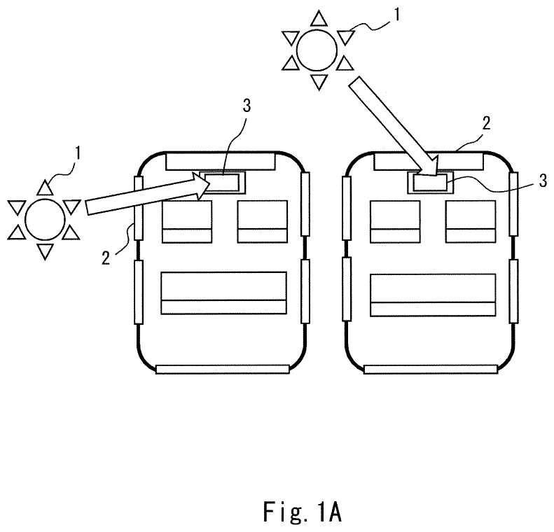

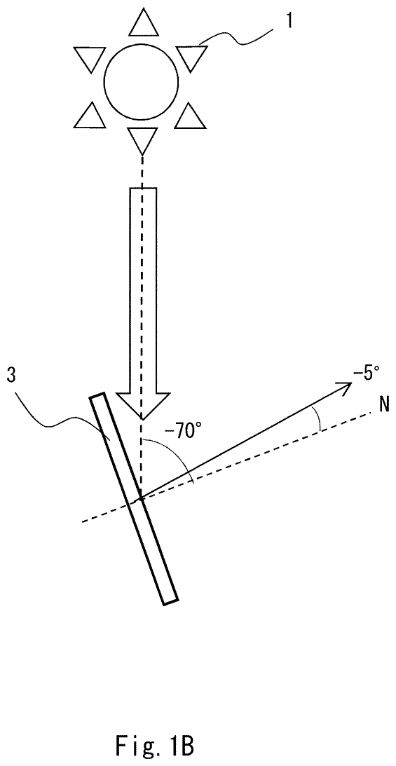

As shown in FIG. 1A, the present evaluation method is a method for evaluating the conspicuousness of fingerprints (fingerprint resistance) after wiping off when a user visually views the display device in a vehicle environment, when light from a light source 1 such as the sun is irradiated onto the surface of a display device 3 mounted inside the vehicle, either directly from outside the vehicle or through a light-transmitting object 2 such as glass included in the vehicle. Further, it is expected that the fingerprint resistance under such circumstances is greatly affected by light irradiated through the windshield or side glass at an angle of 450 or more with respect to the normal to the surface of the display device. As shown in FIG. 1B, the present evaluation method is a method of evaluating the fingerprint resistance after wiping off particularly when light from a light source 1 such as the sun is irradiated at an incidence angle of −70° with respect to the normal N of the surface of the display device 3, and the user visually observes the light at an angle (measurement angle) of −5° with respect to the normal, and can provide evaluation results that better reflect the fingerprint resistance after wiping of the display device in a vehicle environment.

In the present evaluation method, from the viewpoint of obtaining excellent fingerprint resistance after wiping off, the above ΔL*(θ) is preferably 0.1 or less, more preferably 0.10 or less, and still more preferably 0.0 or less. In addition, ΔL*(θ) is more preferably smaller. The fact that ΔL*(θ) is 0 means that the measured values by a variable angle colorimeter are the same for the portion to which the artificial fingerprint liquid is transferred and then once wiped off, and the portion to which the artificial fingerprint liquid is not transferred on the surface of the object (no difference). Therefore, ΔL*(θ) is more preferably closer to 0. Therefore, the fingerprint wiping property does not refer to the physical removability of fingerprints, but to the fact that they are optically invisible (optical invisibility). A detailed method for measuring ΔL*(θ) is described later.

As the artificial fingerprint liquid used in the present evaluation method, conventionally known ones can be used as appropriate, but as described above, it is more preferable to use one that takes solid components such as dust and sebum into consideration. A fingerprint is mainly composed of water and sebum components, and the proportion of sebum components increases as the water evaporates. Therefore, in many cases, it is safe to assume that fingerprints are sebum. Examples of the component constituting sebum include fatty acids, glycerolipids, fatty acid esters, wax esters, cholesterol derivatives, and squalene.

Examples of the fatty acids include oleic acid, stearic acid, linolenic acid, palmitic acid, nonanoic acid, adipic acid, tridecanoic acid, myristoleic acid, tetradecanoic acid, and palmitoleic acid.

Examples of the glycerolipid include monoolein, trimyristin, monocaprylin, triolein, monolaurin, monopalmitin, monostearin, tristearin, tripalmitin, and tricaproin.

Examples of the fatty acid ester include butyl n-octanoate, benzyl octanoate, isobutyl decanoate, ethyl undecanoate, ethyl stearate, ethyl palmitate, ethyl pentadecanoate, benzyl laurate, amyl n-octanoate, and butyl myristate.

Examples of the wax ester include dodecyl stearate, decyl decanoate, hexadecyl palmitate, 3-isoamyl-6-methyl-2-heptyl myristate, myricyl palmitate, cecil palmitate, and myricyl cerotate.

Examples of the cholesterol derivative include cholesterol, 7-dehydrocholesterol, vitamin D, cholic acid, chenodeoxycholic acid, deoxycholic acid, lithocholic acid, progesterone, aldosterone, and cortisol.

Further, the artificial fingerprint liquid can contain one or more types of fine particulate materials selected from inorganic fine particles such as silica fine particles, alumina fine particles, and iron oxide fine particles, and organic fine particles such as keratin fine particles, chitin fine particles, chitosan fine particles, acrylic-based fine particles, styrene-based fine particles, divinylbenzene-based fine particles, polyamide-based fine particles, polyimide-based fine particles, polyurethane-based fine particles, and melamine-based fine particles. In addition, the artificial fingerprint liquid can contain Kanto loam (JIS test powder 1) as a fine particulate material. The average particle size of the fine particulate material can be set as appropriate and is not particularly limited, but for example, the average particle size can be set to 0.05 μm or more and 100 μm or less. In addition, thickeners such as carrageenan and gum arabic, and surfactants such as quaternary ammonium salts and alkylbenzene sulfonates can be added to the artificial fingerprint liquid. The blending proportion of each component constituting the artificial fingerprint liquid can be appropriately set within a range that provides the effects of the present invention, and is not particularly limited.

In addition, the artificial fingerprint liquid used in the present evaluation method can be diluted with an organic solvent as appropriate for use when preparing a thin film (transfer film). As the organic solvent, conventionally known ones can be used as appropriate, such as isopropyl alcohol, methyl ethyl ketone, methoxypropanol, and ethanol.

As the artificial fingerprint liquid, for example, one having the following formulation can be used.
Artificial fingerprint liquid obtained by adding 1.0 g of triolein to 10 g of methoxypropanol as a diluent, and further adding 400 mg of Kanto loam of test powder 1 class 11 specified in JIS Z8901 and stirring.
Artificial fingerprint liquid obtained by adding 200 mg of triolein to 5 g of methoxypropanol as a diluent, further adding 200 mg of keratin (derived from human epithelium, manufactured by Wako Pure Chemical Industries, Ltd.) and stirring, shaking vigorously, then leaving to stand for 10 seconds, and gently collecting the supernatant that does not contain large keratin particles.

Herein, as the artificial fingerprint liquid, it is preferable to appropriately use one that can reproduce the above-described fingerprint components. Specifically, in the present invention, it is preferable to use an artificial fingerprint liquid that is solid at a temperature of 20° C. and becomes a dispersion system at a temperature of 40° C. For example, adding a substance with a melting point higher than room temperature (for example, among the components constituting the sebum described above) to the above-described artificial fingerprint liquid can produce an artificial fingerprint liquid that becomes solid at a temperature of 20° C. and becomes a dispersion system at a temperature of 40° C. The artificial fingerprint liquid with these properties adheres to the coated surface more easily than conventional diluted oleic acid solution with oleic acid alone, can be used for evaluations that take more actual fingerprint adhesion into account, and has excellent adhesion and evaluation reproducibility.

When evaluating the amount of squalene adhered, the squalene content in the artificial fingerprint liquid is preferably 10 to 15% by mass from the viewpoint of performing the evaluation appropriately.

Herein, it is known that the components constituting sebum and the ratios thereof vary from person to person and with age. However, the refractive index of sebum should be between the minimum and maximum values of the refractive index of the components contained in sebum. Among the sebum components described above, the substance with the smallest refractive index is n-butyl octanoate, which has a refractive index of 1.42. In addition, among these sebum components, the substance with the highest refractive index is benzyl octanoate, which has a refractive index of 1.49. Therefore, the refractive index of a fingerprint is considered to be in the range of 1.42 to 1.49.

Conventionally known methods can be applied to transfer the artificial fingerprint liquid, but it is preferable to use the following method. That is, it is preferable to use the method including adhering the artificial fingerprint liquid to the transfer base material by a spin coating method to prepare a transfer foil with a haze value of 7±2%, pressing a pseudo finger against the transfer foil with a load of 60 N, and pressing the pseudo finger against the surface of the object for 2 seconds with a load of 60 N. In the present method, an artificial fingerprint liquid is dropped onto a rotating transfer base material with a spin coating method, and a uniform thin film can be formed by centrifugal force, and thus it is possible to achieve transferring an artificial fingerprint liquid with good reproducibility. Herein, as the transfer base material, conventionally known materials can be used as appropriate, and for example, a polycarbonate plate can be used. In addition, as the pseudo finger, conventionally known ones can be used as appropriate, and for example, natural rubber (rubber hardness: Shore E60, Shore E70 according to JIS K 6253 standard) can be used. In addition, as described above, it is preferable to use an artificial fingerprint liquid that is solid at a temperature of 20° C. and becomes a dispersion system at a temperature of 40° C.

In addition, in the present evaluation method, it is possible to further use a measured value difference Δbrightness(Δluminance) between the portion to which the artificial fingerprint liquid is transferred and then once wiped off, and the portion to which the artificial fingerprint liquid is not transferred on the surface of the display device, obtained by the following formula (2) with a brightness meter (for example, trade name: SR-UL R, manufactured by Topcon Technohouse Corporation).

$$Δ Brightness = brightness of wipping portion after transfer of artificial fingerprint liquid - brightness of artificial fingerprint liquid non - transfer portion \qquad Formula ( 2 )$$

Herein, the light incidence angle is 850 upward the normal to the surface of the measurement sample, the measurement angle is 250 upward and 300 to the right with respect to the normal to the surface of the measurement sample, the measurement distance is 650 mm, and the measurement range is 0.2° (solid angle). In addition, the wiping member and wiping conditions can be the same as those used when measuring ΔL*(θ) above. However, it is difficult to measure brightness in a defined environment due to issues with the installation angle and external light, and the evaluation is not highly reproducible, and thus it is desirable to use the evaluation method of the present invention with a variable angle colorimeter, or to use the evaluation based on brightness and the evaluation of the present invention in combination.

In the present evaluation method, from the viewpoint of obtaining excellent fingerprint resistance after wiping, it is preferable that the A brightness is 0.1 [cd/m²] or less. There is a certain correlation between Δ brightness and ΔL*(θ), and setting both A brightness and ΔL*(θ) to good values can impart better fingerprint resistance after wiping.

When evaluating the fingerprint resistance of the surface of the object after wiping, further, it is preferable to use the amount of squalene adhesion (the amount of fingerprint component adhesion) on the surface of the object (for example, assuming that a fingerprint is adhered). Particularly in the case where the surface of the object is oil-repellent, if the amount of squalene adhered is less than 40 μg, fingerprints are less noticeable and fingerprint resistance is excellent. A detailed method for measuring the amount of squalene adhered will be described later.

### <Laminate>

The laminate of the present invention (hereinafter sometimes referred to as the present laminate) has a surface with a measured value difference ΔL*(θ) of 0.1 or less in the above-described present evaluation method, and thus has excellent fingerprint resistance after wiping and can make fingerprints adhered to the surface less noticeable. As the transfer method of the artificial fingerprint liquid used for evaluation, it is preferable to use the spin coating method described above.

In addition, the present laminate can include a base material, a predetermined layer disposed on the base material, and an outermost layer disposed on the predetermined layer. In addition, the predetermined layer can include a first predetermined layer on the base material side and a second predetermined layer on the outermost layer side. Further, as long as the effects of the present invention can be obtained, another layer (intermediate layer) may be included between the base material and the first predetermined layer, between the first predetermined layer and the second predetermined layer, between the second predetermined layer and the outermost layer, or the like. As the intermediate layer, for example, there can be used each layer such as a desired functional layer, adhesive layer, ultraviolet absorption layer, infrared absorption layer, antireflection layer, soft (impact resistant) layer, hard coat layer, conductive layer, antistatic layer, heat insulation layer, reflective layer, and primer layer. The outermost layer is placed in a situation where touched by human hands during use. The outermost layer may include, for example, an oil-repellent coating layer or a lipophilic coating layer, which will be described later. The present laminate may be used for an operation surface of a touch panel, or a protective member such as a display surface of a display panel or a cover panel covering the display surface. However, the application of the present laminate is not limited to these.

Herein, from the viewpoint of imparting excellent fingerprint resistance after wiping, the refractive index of the first predetermined layer is preferably more than 1.49, more preferably 1.60 or more, preferably 2.00 or less, and more preferably 1.80 or less.

Further, from the viewpoint of imparting excellent fingerprint resistance after wiping, the refractive index of the second predetermined layer is preferably 1.43 or more, more preferably 1.45 or more, preferably 1.49 or less, and more preferably 1.47 or less. The refractive index of a fingerprint is considered to be 1.42 to 1.49 as described above, and thus it is more preferable that the refractive index of the second predetermined layer is close to the average value of 1.46. If the refractive index of the second predetermined layer is 1.43 to 1.49, the interface reflectance between the fingerprint and the surface of the laminate is reduced, and the difference between the fingerprint-adhered portion and other portions is reduced, making the fingerprint more difficult to stand out.

Herein, the refractive index of the base material can be set as appropriate, and for example, a base material with a refractive index of 1.50 can be used. The refractive index of each layer can be measured with an ellipsometer or the like.

The material constituting the base material is not particularly limited, and conventionally known materials can be used as appropriate. For example, the base material may be a transparent resin film or a laminated film (laminate plate) thereof, that is, a resin base material, made of TAC (triacetyl cellulose), PMMA (polymethyl methacrylate), PC (polycarbonate), PET (polyethylene terephthalate), or the like. In addition, as the base material, a conventionally known glass base material (glass substrate) may be used.

In addition, the materials constituting the first predetermined layer, the second predetermined layer, and the outermost layer are not particularly limited, but each of them may be made of a thin film obtained by, for example, vacuum evaporation, sputtering, or wet coating of a layer made of, for example, an active energy ray-curable resin or a thermosetting resin, or a metal oxide (for example, ZrO₂, Al₂O₃, and SiO₂). These layers can be provided with different properties depending on the additives and resins contained.

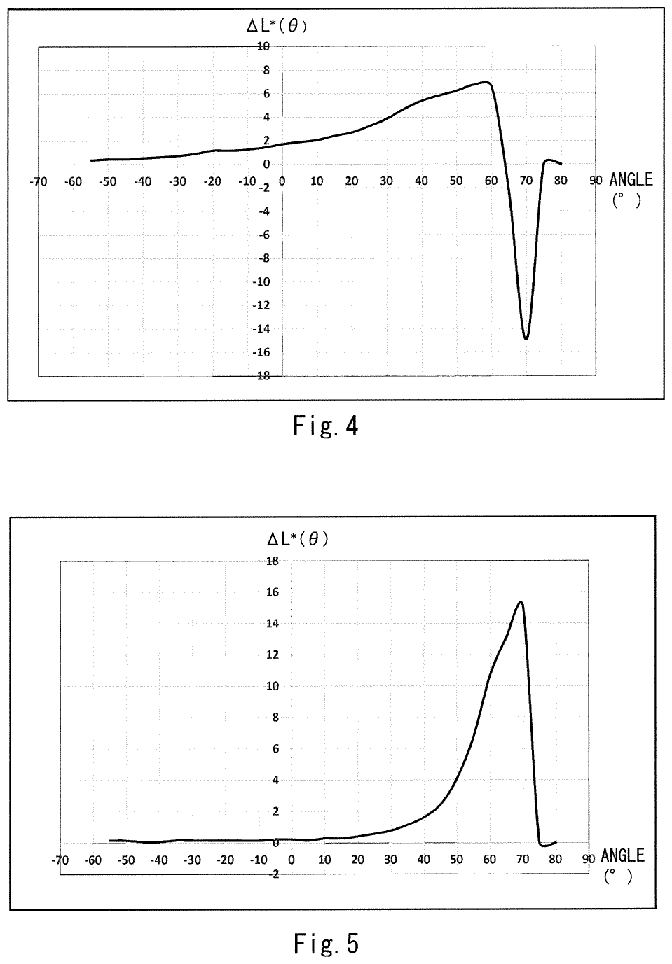

In addition, if the present laminate has, on the surface (the outermost layer), an oil-repellent coating that has the angular dependence of ΔL*(θ) at a light incidence angle of −70°, that is, a negative peak in the specular reflection region and a positive peak at angles other than the specular reflection region, the amount of squalene adhered to the surface of the laminate after the artificial fingerprint liquid is transferred and before wiping off (that is, assuming that a fingerprint is attached) is preferably less than 40 μg. For example, the angular dependence of ΔL*(θ) can be measured by setting the light incidence angle to −70° and the measurement angle from −60° to +85° and calculating ΔL*(θ) for each angle. Satisfying such conditions can reduce ΔL*(θ) due to fingerprint adhesion, and fingerprints can be made less noticeable. When the outermost layer has oil repellency, its refractive index can be, for example, 1.30 to 1.50. The specular reflection region at a light incidence angle of −70° is +70±10°. Herein, FIG. 4 shows a graph showing an example of the angular dependence of ΔL*(θ) at a light incidence angle of −70° after transfer of artificial fingerprint liquid and before wiping operation in a laminate having an oil-repellent coating on the surface. In the graph shown in FIG. 4, the angular dependence of ΔL*(θ) at a light incidence angle of −70° indicates a negative peak in the specular reflection region (+70±100). In addition, in the graph, there are positive (plus) peaks at angles other than the specular reflection region. It can also be interpreted that having a negative peak in the specular reflection region means that the angle (°) of the position at the apex of the negative peak is within the range of the specular reflection region (70° in FIG. 4). In addition, it can be interpreted that having a positive peak at an angle outside the specular reflection region means that the angle (°) of the position at the apex of the positive peak is within the range outside the specular reflection region (550 in FIG. 4).

In addition, it is preferable that the present laminate has, on the surface (the outermost layer), a lipophilic coating in which the angular dependence of ΔL*(θ) at a light incidence angle of −70° does not indicate a positive peak at angles other than the specular reflection region. The lipophilic coating can have a positive peak only in the specular reflection region in the angular dependence of ΔL*(θ) at a light incidence angle of −70°. Having such a lipophilic coating surface makes it possible to reduce ΔL*(θ) due to fingerprint adhesion, and can lead to less noticeable fingerprints. Specular reflection increases with the lipophilic coating, but the conspicuousness of fingerprints can be easily controlled by making the refractive index of the second predetermined layer close to the refractive index of the fingerprint component. When the outermost layer has lipophilicity, its refractive index can be, for example, 1.30 to 1.50. Herein, FIG. 5 shows a graph showing an example of the angular dependence of ΔL*(θ) at a light incidence angle of −70° after transfer of artificial fingerprint liquid and before wiping operation in a laminate having a lipophilic coating on the surface. In the graph shown in FIG. 5, the angular dependence of ΔL*(θ) at a light incidence angle of −70° does not indicate a positive peak at angles other than the specular reflection region (+70±10°), and indicates a positive peak only in the specular reflection region. The angle (°) of the position at the apex of the positive peak is within the range of the specular reflection region (70° in FIG. 5).

The wiping property of the surface of the laminate does not depend on the properties of the outermost layer (for example, oil repellency or lipophilicity). In addition, the above-described angular dependence of the variable angle ΔL*(θ) is not limited to the light incidence angle of −70°, and for example, the same behavior is observed even when the light incidence angle is −30°.

In the present laminate having the lipophilic coating, the distance from the surface of the outermost layer disposed on the second predetermined layer to the second predetermined layer is preferably 60 nm or less. If the distance is 60 nm or less, optical interference due to the difference between the refractive index of the lipophilic outermost layer and the refractive index of fingerprints (sebum) adhered to the surface can be suppressed, and fingerprints can be made less noticeable. When the lipophilic outermost layer is directly laminated on the second predetermined layer, the thickness of the outermost layer is preferably 60 nm or less. In addition, when another layer is disposed between the outermost layer and the second predetermined layer, the total thickness of the outermost layer and the other layer is preferably 60 nm or less. This can maintain the lipophilicity of the surface of the outermost layer while reducing the optical influence due to its refractive index. In other words, the fingerprint can be regarded to be substantially directly adhered to the second predetermined layer.

In the present laminate, from the viewpoint of providing excellent fingerprint resistance after wiping, the A brightness on the surface calculated from the above-described formula (2) is preferably 0.1 [cd/m²] or less.

Each numerical value described above is based on simulation results by the inventors. The simulations are performed under various conditions in which the refractive index (including the refractive index of air) and thickness of each member of the laminate are changed as appropriate, and a desired numerical range is determined based on the results. For example, in the present laminate with a lipophilic coating and in a simulation in which the distance from the surface of the outermost layer disposed on the second predetermined layer to the second predetermined layer was determined to be 60 nm or less, only the thickness of the lipophilic outermost layer of the laminate was changed. In addition, the thickness of a fingerprint is typically 10 to several hundred nm in actual measurements, but in the present simulation, 50 nm was used as a representative value. The optical interference ΔY in the simulation is represented as ΔY=∫ photopic luminous efficiency function×D65 light source function×(R_{A}−R_{B}) dλ. Herein, R_{A} represents the intensity reflectance at the surface of the laminate, and R_{B} represents the intensity reflectance at the fingerprint adhered to the surface of the laminate. Y is in a proportional relationship with lightness L*, and thus if ΔY becomes a small value, ΔL*(θ) also becomes a small value.

In the simulation, the intensity reflectance Rm is represented by the following formula I.

$$[ Mathematical Formula 1 ]$$

$${R}_{m} = \frac{{( {η}_{a} {m}_{11} - {η}_{s} {m}_{22} )}^{2} + {( {η}_{a} {η}_{s} {m}_{12} - {m}_{21} )}^{2}}{{( {η}_{a} {m}_{11} + {η}_{s} {m}_{22} )}^{2} + {( {η}_{a} {η}_{s} {m}_{12} + {m}_{21} )}^{2}} \qquad Formula I$$

In the formula I, ηa represents the refractive index of air, is represents the refractive index of the base material, and m represents the component of the characteristic matrix [M]. The characteristic matrix [M] is represented by the following formula II.

$$\begin{matrix}[ Mathematical Formula 2 ] & \end{matrix}$$

$$\begin{matrix}[ M ] = {\prod }_{j = 1}^{n} [ {M}_{j} ] = ( \begin{matrix}{m}_{11} & {m}_{12} \\ {m}_{21} & {m}_{22}\end{matrix} ) \\ [ {M}_{j} ] = ( \begin{matrix}cos {ϕ}_{{}_{j}} & i {η}_{j}^{- 1} sin {ϕ}_{{}_{j}} \\ i {η}_{j} sin {ϕ}_{{}_{j}} & cos {ϕ}_{{}_{j}}\end{matrix} )\end{matrix} \qquad Formula II$$

In the formula II, n: number of layers laminated on the base material, j: order of each layer laminated on the base material from the outermost layer (top layer), η: optical admittance, and Φ: optical path length. If a fingerprint is adhered to the surface of the laminate, it is assumed that the fingerprint is on the outermost layer of the laminate. In addition, η is represented by the following formula III, and Φ is represented by the following formula IV.

$$\begin{matrix}[ Mathematical Formula 3 ] & \end{matrix}$$

$${η}_{j} = \{ \begin{matrix}{N}_{j} / cos {φ}_{j} & ( for p - population ) \\ - {N}_{j} cos {φ}_{j} & ( for s - polarization )\end{matrix} ( j = 1 ∼ n ) \qquad Formula III$$

$$\begin{matrix}[ Mathematical Formula 4 ] & \end{matrix}$$

$$\begin{matrix}{ϕ}_{{j}_{}} = {K}_{j} {d}_{j} \\ {K}_{j} = \frac{2 π {N}_{j}}{λ} cos {φ}_{j}\end{matrix} \qquad Formula IV$$

In the formula III and formula IV, N: refractive index of each layer, φ: angle of incidence on each layer. In addition, in the formula IV, d: thickness of each layer, and λ: wavelength of light.

In the present embodiment, the distance from the surface of the laminate to the second predetermined layer, the refractive index of each layer, and the like can be measured non-destructively with an ellipsometer. In addition, the laminate may be cut, and the cut surface may be subjected to ion milling or FIB (Focused Ion Beam) processing, and then observed or analyzed. For example, elements and structures may be identified by performing qualitative analysis with XPS (X-ray photoelectron spectroscopy) or the like. In addition, the number of layers and film thickness may be confirmed with an electron microscope. It is also possible to confirm the structure with higher accuracy by comparing the measurement results with the ellipsometer and other observation or analysis results.

### <Method for Producing Laminate>

In the method for producing a laminate of the present invention (hereinafter sometimes referred to as the present production method), the laminate is produced so that the above-described ΔL*(θ) is 0.1 or less on the surface of the laminate. The laminate obtained by the present production method can have excellent fingerprint resistance based on wiping property. In the present production method, the surface of the laminate can also be surface-treated so that ΔL*(θ) is 0.1 or less. The surface treatment method is not particularly limited as long as the effects of the present invention can be obtained, and conventionally known methods can be used. For example, an AG (Anti-Glare) coating can be applied to the surface of the base material. AG coating can diffuse reflected light and control reflection and glare by creating significantly fine irregularities on the surface of the base material.

The laminate of the present invention can be produced, for example, by the following procedure.

First, a coating liquid containing an active energy ray-curable resin is applied onto a base material such as a resin base material or a glass base material with a bar coater or the like, and dried by heating (for example, 80° C. for 90 seconds) if necessary. Thereafter, active energy ray curing is performed in an inert gas (for example, nitrogen gas) atmosphere to form a hard coat coating film with a predetermined thickness (for example, 5 μm).

The active energy ray-curable resin contains a polymerizable compound that undergoes a curing reaction and can form a cured product upon irradiation with active energy rays. As the polymerizable compound, monofunctional monomers, polyfunctional monomers, oligomers, and polymers having a vinyl group or (meth)acryloyl group can be used.

Examples of the monofunctional monomer include: (meth)acrylic acid esters such as methyl (meth)acrylate, ethyl (meth)acrylate, isopropyl (meth)acrylate, n-butyl (meth)acrylate, t-butyl (meth)acrylate, isobutyl (meth)acrylate, n-hexyl (meth)acrylate, 2-ethylhexyl (meth)acrylate, isodecyl (meth)acrylate, lauryl (meth)acrylate, stearyl (meth)acrylate, cetyl (meth)acrylate, isobonyl (meth)acrylate, cyclohexyl (meth)acrylate, tricyclodecyl (meth)acrylate, benzyl (meth)acrylate, Tetrahydrofurfuryl (meth)acrylate, dicyclopentenyl oxyethyl (meth)acrylate, dicyclopentanyl (meth)acrylate, pentamethylpiperidyl (meth)acrylate, ethyl (meth)acrylate hexahydrophthalate, ethyl (meth)acrylate 2-hydroxypropylphthalate, 2-hydroxybutyl (meth)acrylate, butoxyethyl (meth)acrylate, phenoxyethyl (meth)acrylate, (meth)acrylic acid methoxydiethylene glycol, (meth)acrylic acid methoxytriethylene glycol, and (meth)acrylic acid methoxypolyethylene glycol; styrene, α-methylstyrene, p-methoxystyrene, m-methoxystyrene, di-t-butyl fumarate, di-n-butyl fumarate, diethyl fumarate, mono(di)methyl itaconate, mono(di)ethyl itaconate, N-isopropylacrylamide, and N-vinyl-2-pyrrolidone.

Examples of the polyfunctional monomer include esterified products of polyhydric alcohol and (meth)acrylic acid, and polyfunctional polymerizable compounds containing two or more (meth)acryloyl groups such as urethane-modified acrylates. Examples of the polyhydric alcohol include: dihydric alcohols such as ethylene glycol, diethylene glycol, triethylene glycol, tetraethylene glycol, polyethylene glycol, propylene glycol, dipropylene glycol, tripropylene glycol, tetrapropylene glycol, polypropylene glycol, propanediol, butanediol, pentanediol, hexanediol, neopentyl glycol, 2-ethyl-1,3-hexanediol, 2,2′-thiodiethanol, and 1,4-cyclohexanedimethanol; and trivalent or higher alcohols such as trimethylolpropane, glycerol, pentaerythritol, diglycerol, dipentaerythritol, and ditrimethylolpropane.

Urethane-modified acrylate can be obtained by a urethane reaction between an organic isocyanate having a plurality of isocyanate groups in one molecule and a (meth)acrylic acid derivative having a hydroxyl group. Examples of the organic isocyanate having a plurality of isocyanate groups in one molecule include: organic isocyanates having two isocyanate groups in one molecule, such as hexamethylene diisocyanate, isophorone diisocyanate, tolylene diisocyanate, naphthalene diisocyanate, diphenylmethane diisocyanate, xylerine diisocyanate, and dicyclohexylmethane diisocyanate; and organic isocyanates that are obtained by isocyanurate-modification, adduct-modification, or biuret-modification of the above-described organic isocyanates and have three isocyanate groups in one molecule.

Examples of the oligomer having a vinyl group or a (meth)acryloyl group include: each oligomer of polyester oligomer, epoxy oligomer, urethane oligomer, polyether oligomer, alkyd oligomer, polybutadiene oligomer, polythiol polyene oligomer, and spiroacetal oligomer; and an oligomer obtained by adding a vinyl group or (meth)acryloyl group to an oligomer made of a polyfunctional (meth)acrylate ester of a polyhydric alcohol. Examples of the polymer having a vinyl group or (meth)acryloyl group include a polymer of the above-described oligomer having a vinyl group or (meth)acryloyl group.

In addition, the coating liquid can be blended, if necessary, with additives such as diluting solvents, beads, fillers, photodecomposition or thermal decomposition polymerization initiator, metal oxides, surfactants, ultraviolet absorbers, infrared absorbers, antioxidants, photosensitizers, light stabilizers, and silane coupling agents.

Examples of the diluting solvent include toluene, xylene, ethyl acetate, propyl acetate, butyl acetate, methylcellosolve, ethyl cellosolve, ethyl cellosolve acetate, methyl alcohol, ethyl alcohol, isopropyl alcohol, butyl alcohol, acetone, methyl ethyl ketone, methyl isobutyl ketone, cyclohexanone, hexane, heptane, octane, decane, dodecane, propylene glycol monomethyl ether, and 3-methoxybutanol.

Examples of the polymerization initiator include benzophenones, acetophenones, α-amyloxime ester, Michler benzoyl benzoate, tetramethylthiuram monosulfide, and thioxanthone, and specific examples include 1-hydroxycyclohexyl phenyl ketone, 2-hydroxy-2-methyl-1-phenylpropan-1-one, 2-methyl-1-[4-(methylthio)phenyl]-2-morphelinopropan-1-one, 1-[4-(2-hydroxyethoxy)phenyl]-2-hydroxy-2-methyl-1-propane-1-one, benzoin, 2,2-dimethoxy-1,2-diphenylethan-1-one, benzophenone, [4-(methylphenylthio)phenyl]phenylmethanone, 4-hydroxybenzophenone, 4-phenylbenzophenone, 3,3′,4,4′-tetra(t-butylperoxycarbonyl)benzophenone, 2-chlorothioxanthone, 2,4-diethylthioxanthone, α-amyloxime ester, Michler benzoyl benzoate, and tetramethylthuram monosulfide.

Examples of the metal oxide include silica, hollow silica, aluminum oxide (alumina), titanium oxide, antimony oxide, zinc oxide, tin oxide, and zirconium oxide.

The surfactant is used for the purpose of compatibilization when blending various raw materials and for the purpose of improving the smoothness of coatings, and is not particularly limited, but examples thereof include acrylic-based copolymers (ionic and nonionic), methacrylic-based copolymers, leveling agents for solvent-based paints, and polysiloxane-based compounds.

As the photosensitizer, the above-described known compounds for polymerization initiators are used, and examples thereof include tertiary amines such as tributylamine, triethylamine, polyethyleneimine, poly-n-butylphosophine, p-dimethylaminobenzoic acid ethyl ester, and p-dimethylaminobenzoic acid isoamyl ester.

The blending proportions of these various components can be appropriately set within the range in which the effects of the present invention can be obtained, and are not particularly limited. Appropriately blending these various components can adjust various properties such as optical properties, coating film properties, and durability of the produced laminate. In addition, for the active energy ray and the irradiation amount thereof, conventionally known conditions can be used as appropriate, and for example, a metal halide lamp can be used.

Then, the obtained hard coat coating film is subjected to a plasma treatment followed by a vacuum evaporation method to form AR (Anti-Reflection) coating film as each of a first predetermined layer (high refractive index layer) and a second predetermined layer (low refractive index layer). Herein, the constituent material of each layer can be appropriately selected depending on the desired refractive index and reflectance, and the number of layers, thickness, and the like can also be appropriately set. For example, the first predetermined layer and the second predetermined layer may each be formed one layer at a time, or may be a laminate in which a plurality of layers are alternately laminated. In addition, each thickness of the first predetermined layer and the second predetermined layer can be, for example, 1 nm or more and 200 nm or less. Further, each layer may be formed by a sputtering method, a wet coating method, or the like.

As the first predetermined layer, there can be used niobium pentoxide (Nb₂O₅), titanium oxide (TiO₂), tungsten oxide (WO₃), cerium oxide (CeO₂), tantalum pentoxide (Ta₂O₅), zinc oxide (ZnO), indium oxide (In₂O₃), tin oxide (SnO₂), hafnium oxide (HfO₂), indium tin oxide (ITO), zirconium oxide (ZrO₂), aluminum oxide (Al₂O₃), antimony oxide (Sb₂O₃), neodymium oxide (Nd₂O₃), zinc sulfide (ZnS), and the like. Further, if it is desired to impart conductive properties to the first predetermined layer, for example, ITO and indium zinc oxide (IZO) can be used. Further, as the first predetermined layer, there may be used thermosetting resins such as phenol resin, urea resin, diallyl phthalate resin, melamine resin, guanamine resin, unsaturated polyester resin, polyurethane resin, epoxy resin, amino alkyd resin, melamine-urea condensation resin, silicon resin, and polysiloxane resin. In this case, the first predetermined layer can also contain an inorganic material such as silica, alumina, zirconia, and titania, or an organic material such as acrylic resin.

From the viewpoint of availability and cost, the second predetermined layer preferably contains an oxide of Si, and is preferably a layer made of SiO₂ (an oxide of Si) or the like as a main component. Herein, the term “main component” refers to the component with the highest content among the components contained in the target (herein, the second predetermined layer). The second predetermined layer can contain, in addition to SiO₂, elements such as Na for the purpose of improving durability, Zr, Al, and N for the purpose of improving hardness, and Zr and Al for the purpose of improving alkali resistance. The second predetermined layer can also contain, for example, magnesium fluoride (MgF₂), sodium fluoride (NaF), cryolite (Na₃AlF₆), thiolite (Na₅Al₃F₁₄), lithium fluoride (LiF), aluminum fluoride (AlF₃), calcium fluoride (CaF₂), styrontium fluoride (SrF₂), zirconium fluoride (ZrF₄), barium fluoride (BaF₂), and yttrium fluoride (YF₃).

More specifically, for example, as the first predetermined layer, an AR coating film (for example, film thickness: 150 nm) having a refractive index of 1.70 can be formed by a vacuum evaporation method with raw materials: ZrO₂/Al₂O₃. Further, for example, as the second predetermined layer, an AR coating film (for example, film thickness: 90 nm) having a refractive index of 1.46 can be formed on the first predetermined layer by a vacuum evaporation method with raw materials: SiO₂.

Then, a silane coupling agent (for example, a perfluoropolyether-based silane coupling agent) is applied on the second predetermined layer with a spray method, and cured for a predetermined period of time (for example, 12 hours) in a high temperature and high humidity (for example, temperature of 50° C. and relative humidity of 90%) environment to form an AF (Anti-Fingerprint) coating film with a predetermined thickness (for example, 10 nm) as the outermost layer. As described above, the laminate of the present invention can be obtained.

As the outermost layer, there can be used an oil-repellent coating layer formed by using a fluorine compound having at least one functional group selected from the group consisting of a fluoroalkyl group, a fluorooxyalkyl group, a fluoroalkenyl group, a fluoroalkanediyl group, and a fluorooxyalkanediyl group. Some of these functional groups may have —H groups remaining, or all H groups may be replaced with fluorine (—F) groups. In addition, there may be branches in the structure, and a plurality of the branches may be connected to form a dimer, trimer, oligomer, or polymer structure. In addition, the fluorine compound may have a silyl ether group, an alkoxysilyl group, a silanol group obtained by hydrolyzing an alkoxysilyl group, or reactive groups such as a carboxyl group, hydroxyl group, epoxy group, vinyl group, allyl group, acryloyl group, and methacryloyl group.

As the fluorine compound, for example, a compound represented by the following general formula (A) can be used.

R^{f1}—R²-D¹ General formula (A)

(R^{f1} represents a site containing a fluoroalkyl group, a fluorooxyalkyl group, a fluoroalkenyl group, a fluoroalkanediyl group, and a fluorooxyalkanediyl group, and R² represents an alkanediyl group, an alkantriyl group, and an ester structure, an urethane structure, an ether structure, and a triazine structure derived from them, and D¹ represents a reactive site).

Examples of the compound represented by the general formula (A) include 2,2,2-trifluoroethyl acrylate, 2,2,3,3,3-pentafluoropropyl acrylate, 2-perfluorobutylethyl acrylate, 3-perfluorobutyl-2-hydroxypropyl acrylate, 2-perfluorohexylethyl acrylate, 3-perfluorohexyl-2-hydroxypropyl acrylate, 2-perfluorooctyl ethyl acrylate, 3-perfluorooctyl-2-hydroxypropyl acrylate, 2-perfluorodecylethyl acrylate, 2-perfluoro-3-methylbutylethyl acrylate, 3-perfluoro-3-methoxybutyl-2-hydroxypropyl acrylate, 2-perfluoro-5-methylhexylethyl acrylate, 3-perfluoro-5-methylhexyl-2-hydroxypropyl acrylate, 2-perfluoro-7-methyloctyl-2-hydroxypropyl acrylate, tetrafluoropropyl acrylate, octafluoropentyl acrylate, dodecafluoroheptyl acrylate, hexadecafluorononyl acrylate, hexafluorobutyl acrylate, 2,2,2-trifluoroethyl methacrylate, 2,2,3,3,3-pentafluoropropyl methacrylate, 2-perfluorobutyl ethyl methacrylate, 3-perfluorobutyl-2-hydroxypropyl methacrylate, 2-perfluorooctyl ethyl methacrylate, 3-perfluorooctyl-2-hydroxypropyl methacrylate, 2-perfluorodecylethyl methacrylate, 2-perfluoro-3-methylbutylethyl methacrylate, 3-perfluoro-3-methylbutyl-2-hydroxypropyl methacrylate, 2-perfluoro-5-methylhexylethyl methacrylate, 3-perfluoro-5-methylhexyl-2-hydroxypropyl methacrylate, 2-perfluoro-7-methyloctylethyl methacrylate, 3-perfluoro-7-methyloctylethyl methacrylate, tetrafluoropropyl methacrylate, octafluoropentyl methacrylate, octafluoropentyl methacrylate, dodecafluoroheptyl methacrylate, hexadecafluorononyl methacrylate, 1-trifluoromethyltrifluoroethyl methacrylate, hexafluorobutyl methacrylate, and triacryloyl-heptadecafluorononenyl-pentaerythritol. In addition to these, a conventionally known oil-repellent coating layer can be used as the outermost layer.

In addition, as the outermost layer, for example, a hydrolyzable organosilane compound (for example, one containing a hindered ester group) or a lipophilic coating layer with a hydrolyzed condensate thereof can be used. The organosilane compound can contain a hindered ester group having excellent lipophilicity and heat resistance, and a hydrolyzable silyl group (for example, an alkoxysilyl group) or a hydroxyl group-containing silyl group. As the lipophilic coating layer, conventionally known ones can be used, and for example, organosilane compounds described in Japanese Unexamined Patent Application Publication No. 2020-203838 can be used.

### <Display Device>

The display device of the present invention (hereinafter sometimes referred to as the present display device) is not particularly limited as long as it includes the present laminate, and any conventionally known display device can be used as appropriate. The present display device having the present laminate has excellent fingerprint resistance, and thus can be suitably used in various electronic devices such as display devices equipped with touch panels, display panels, and the like.

### EXAMPLE

The present invention will be described in more detail below using Examples, but the present invention is not limited to these Examples. Examples 1 to 15 described below are examples for evaluating the fingerprint resistance evaluation method of the present invention, and Examples 16 to 30 are examples for evaluating conventional evaluation methods.

### (Confirmation of Correlation Between ΔL*(θ) Value and Sensory Evaluation Results)

### (1) Preparation of Measurement Sample

First, 2.0 g of an artificial fingerprint liquid was dropped onto a colorless and transparent polycarbonate plate with an external size of 115 mm×90 mm and a thickness of 2.0 mm, and spin coating was performed to prepare a transfer foil of the artificial fingerprint liquid so that the HAZE value was 7±2%. The HAZE value was measured with a haze meter (trade name: NDH-5000, manufactured by Nippon Denshoku Industries Co., Ltd.), and was determined by HAZE value (%)=diffuse transmittance/total light transmittance. The artificial fingerprint liquid used had the property of being solid at a temperature of 20° C. and becoming a dispersion system at a temperature of 40° C.

Then, a natural rubber pad (natural rubber, rubber hardness: Shore E70) with a diameter of 20 mm and a thickness of 2 mm was pressed against the transfer foil of the artificial fingerprint liquid for 2 seconds with a load of 60 N, and then the natural rubber pad with the artificial fingerprint liquid transferred was pressed onto the sample for 2 seconds with a load of 60 N to transfer the artificial fingerprint liquid to the sample, thereby preparing a sample for measurement. In the present example, the purpose is to verify the correlation between ΔL*(0) and the sensory evaluation results, and thus a detailed explanation of each sample will be omitted, but for example, the following samples are used in Examples below.

Example 1: A sample (reflectance: 0.3%) obtained by forming a first layer with a refractive index of 2.33 and a second layer with a refractive index of 1.46 on a glass base material with AG coating on the surface thereof, and performing oil-repellent coating on the surface thereof. Example 2 and Example 3 (Example 3 and Example 17 are the same sample): samples obtained by changing the glass base material of Example 1 to a film base material and a resin plate, respectively (both of reflectances: 0.3%). Example 4 (same sample as Example 16): sample obtained by using a resin plate with an AG coating on the surface as a base material and providing a lipophilic coating to the surface (reflectance: 4.5%). Example 5: A sample (reflectance: 0.4%) obtained by forming a first layer with a refractive index of 2.33 and a second layer with a refractive index of 1.46 on a resin plate with AG coating on the surface thereof.

### (2) Measurement of Diffuse Reflection Fingerprint Resistance ΔL*(θ)

In the obtained measurement sample, for each of the portion to which the artificial fingerprint liquid was transferred and then once wiped off and the portion to which the artificial fingerprint liquid was not transferred, that is, the portion to which the artificial fingerprint liquid was adhered and then wiped off, and the portion to which the artificial fingerprint liquid was not adhered, the variable angle lightness L* defined by the CIE1976L*a*b* display system was measured by using a variable angle colorimeter (trade name: VC-2, manufactured by Suga Test Instruments Co., Ltd.). The difference between both measured values ΔL*(θ) was calculated according to the following formula (1).

$$Δ L * ( θ ) = L * of wipping portion after transfer of artificial fingerprint liquid - L * of the artificial fingerprint liquid non - transfer portion \qquad Formula ( 1 )$$

The light incidence angle was −70° with respect to the normal to the measurement sample surface, and the measurement angle was −5° with respect to the normal to the measurement sample surface. In addition, wiping was performed by once passing the portion to which the artificial fingerprint liquid was adhered through Scotch Brite No. 5000 (trade name, manufactured by 3M Japan Limited) as a wiping member, 40 mm×70 mm, with a load of 500 g.

### (3) Implementation of Sensory Evaluation

For the obtained measurement sample, there was constructed an evaluation environment that reproduced the incidence angle of sunlight and the positional relationship between the display device and the user in the actual vehicle environment, and sensory evaluation by humans was performed based on the following sensory evaluation criteria. Specifically, artificial sunlight lighting was used as sunlight, the illuminance was 30,000 to 60,000 lux, the incidence angle of the artificial sunlight lighting was −70°, and the observation angle by the user was −5°.

### Sensory Evaluation Criteria

3: completely wiped off
2: Could not be completely wiped off and a little remained
1: cannot be wiped off at all

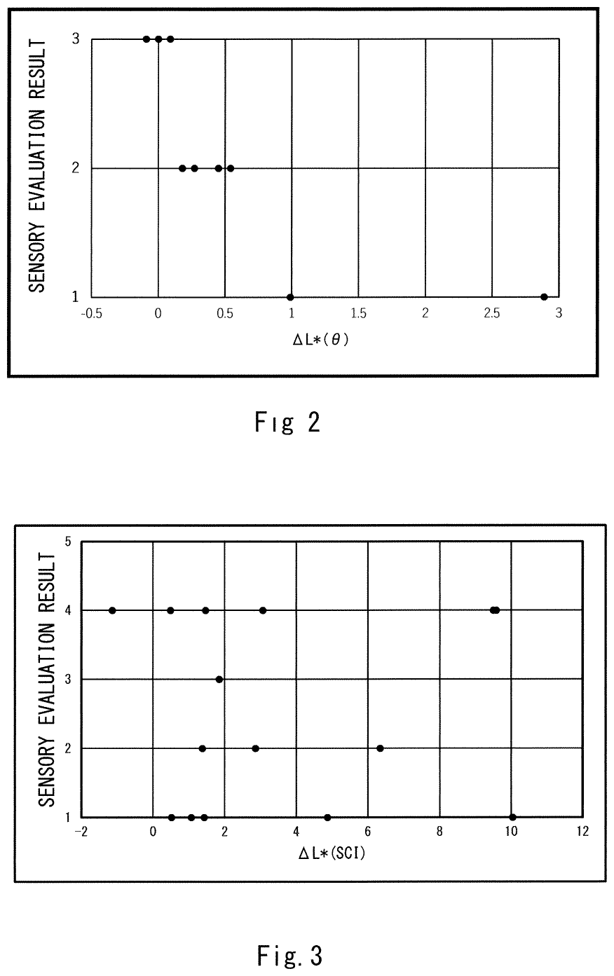

According to the above procedure, for 15 pieces of measurement samples 1 to 15, measurement of the ΔL*(θ) value and sensory evaluation by the user were performed, and the correlation between the ΔL*(θ) value and the sensory evaluation results was confirmed. Table 1 below shows the results of each measurement sample, and FIG. 2 shows a graph showing the correlation of each measurement sample.

TABLE 1

| | | | SENSORY |
|---|---|---|---|
| | MEASUREMENT | ΔL* | EVALUATION |
| EXAMPLE | SAMPLE | (θ) | RESULT |
| 1 | 1 | 2.89 | 1 |
| 2 | 2 | 0.54 | 2 |
| 3 | 3 | 0.99 | 1 |
| 4 | 4 | −0.09 | 3 |
| 5 | 5 | 0.27 | 2 |
| 6 | 6 | 0.27 | 2 |
| 7 | 7 | 0.45 | 2 |
| 8 | 8 | 0 | 3 |
| 9 | 9 | 0.45 | 2 |
| 10 | 10 | 0.18 | 2 |
| 11 | 11 | 0.09 | 3 |
| 12 | 12 | 0.27 | 2 |
| 13 | 13 | 0.18 | 2 |
| 14 | 14 | 0.09 | 3 |
| 15 | 15 | 0 | 3 |

As shown in FIG. 2, it has been confirmed that there was a certain correlation between the ΔL*(θ) value and the sensory evaluation results. In addition, it has been found that when ΔL*(θ) was 0.1 or less, the sensory evaluation result showed 3, indicating excellent fingerprint resistance.

### (Confirmation of Correlation Between Conventional Fingerprint Resistance Evaluation Method and Sensory Evaluation Results)

### (1) Preparation of Measurement Sample

Eight sheets of gauze were laid down, dripped with one drop of oleic acid, and left for 10 seconds. Then, silicone rubber was placed on the portion with oleic acid dripped, provided with a load of 500 g, and left for 2 seconds. The silicone rubber was placed on eight new sheets of gauze, provided with a load of 500 g, and left for 2 seconds. Subsequently, the silicone rubber was transferred onto the sample, provided with a load of 500 g, and left for 2 seconds to transfer the oleic acid to the sample, thereby preparing a sample for measurement.

### (2) Measurement of ΔL* (SCI)

In the obtained measurement sample, for the portion to which oleic acid was transferred and the portion to which oleic acid was not transferred, that is, the portion to which oleic acid is adhered and the portion to which oleic acid was not adhered, the lightness L* defined by CIE1976L*a*b* display system was measured by using a color difference meter (trade name: CM-5, manufactured by Konica Minolta Inc.). The difference between both measured values ΔL* (SCI) was calculated according to the following formula (3).

$$ΔL * ( SCI ) = L * of oleic acid transfer portion - L * of oleic acid non - transfer portion \qquad Formula ( 3 )$$

### (3) Implementation of Sensory Evaluation

A human sensory evaluation was performed on the obtained measurement sample by using the sensory evaluation method described above. According to the above procedure, the ΔL* (SCI) value was measured and the sensory evaluation by the user was performed for 15 pieces of measurement samples 16 to 30, and the correlation between the ΔL*(SCI) value and the sensory evaluation results was confirmed. The following criteria were used for sensory evaluation.

### Sensory Evaluation Criteria

5: Fingerprint marks were not visible.
4: Fingerprint marks were hardly visible.
3: Fingerprint marks were slightly visible.
2: Fingerprint marks were visible.
1: Fingerprint marks were clearly visible.

Subsequently, Table 2 below shows the results of each measurement sample, and FIG. 3 shows a graph showing the correlation of each measurement sample. ΔL*(SCI) is not the value after wiping, but, it is found from FIG. 3 that the conventional evaluation method does not provide results that reflect the actual sensory evaluation in the vehicle environment.

TABLE 2

| | | | SENSORY |
|---|---|---|---|
| | MEASUREMENT | ΔL* | EVALUATION |
| EXAMPLE | SAMPLE | (SCI) | RESULT |
| 16 | 16 | −1.14 | 4 |
| 17 | 17 | 6.33 | 2 |
| 18 | 18 | 3.06 | 4 |
| 19 | 19 | 10.04 | 1 |
| 20 | 20 | 1.84 | 3 |
| 21 | 21 | 4.86 | 1 |
| 22 | 22 | 9.58 | 4 |
| 23 | 23 | 9.49 | 4 |
| 24 | 24 | 0.51 | 1 |
| 25 | 25 | 1.06 | 1 |
| 26 | 26 | 2.86 | 2 |
| 27 | 27 | 1.42 | 1 |
| 28 | 28 | 1.37 | 2 |
| 29 | 29 | 1.46 | 4 |
| 30 | 30 | 0.48 | 4 |

For the optical index ΔL* (SCI), which indicates the reflection intensity of all angles angle-integrated by an integrating sphere, conventionally used as an evaluation index of fingerprint resistance as described above, it has been found to be difficult to properly evaluate fingerprint resistance regardless of whether or not it was wiped off. In addition, with the conventional transfer method described above, there are a case where oleic acid remains on the gauze and a case where droplet repellency occurs, and in some cases, it was not possible to transfer oleic acid to the sample with good reproducibility.

### (Measurement of Amount of Squalene Adhered)

Assuming a laminate with fingerprints adhered, after transferring the artificial fingerprint liquid to the surface of the measurement sample and before the wiping operation, for the artificial fingerprint liquid adhered to the surface of the measurement sample to which the artificial fingerprint liquid had been transferred, quartz wool from which adhered oil had been removed by solvent washing was impregnated with n-hexane, and the surface was scrubbed and rinsed with n-hexane to collect the washing liquid in a 40 mL container. The quartz wool used was put in the container, which was then sealed tightly, and 50 mL of the solution subjected to ultrasonic extraction for 5 minutes was weighed out and subjected to a measuring device to measure the amount of squalene. The calibration curve used to measure the amount of squalene was prepared by applying a standard solution that had been diluted stepwise with n-hexane to the measuring device, and using the adjusted concentration and the area value obtained from the measurement results. The squalene content in the artificial fingerprint liquid used was 13% by mass.

### Measuring Device

Gas chromatography (GC): Agilent Technologies 7890B (trade name)
Mass spectrometer (MS): JEOL JMS-Q1500GC (trade name)

### GC Conditions

Inlet temperature: 280° C.
Introduction method: splitless method
Introduced amount: 2 L (using autosampler)
Analytical column: Agilent Technologies (trade name) 5% phenyl-95% methylsiloxane
Carrier gas: helium
Head pressure: 64.50 kPa (constant pressure)
Oven conditions: 60° C. (3 min)−20° C./min-300° C.

### MS Conditions

Ionization method: EI
Measurement method: scan measurement with electron ionization method
Measurement mass range: m/Z=40 to 425
Ionization voltage: 70 eV
Ion source temperature: 200° C.
Interface temperature: 250° C.

As the above measurement sample, there was used a display device equipped with an oil-repellent coating, specifically having the angular dependence of ΔL*(θ) at a light incidence angle of −70° indicating a negative peak in the specular reflection region (70±10°) and a positive peak at angles outside the specular reflection region. The angular dependence of ΔL*(θ) was determined by setting the measurement angle to −60° to +85° and calculating ΔL*(θ) for each angle in a method similar to the method for measuring the diffuse reflection fingerprint resistance ΔL*(θ) described above. Table 3 below shows the relationship between the amount of squalene adhered after transferring the artificial fingerprint liquid and before the wiping operation (assuming that a fingerprint is attached), and ΔL*(θ) after transferring the artificial fingerprint liquid and after the wiping operation, in the measurement sample.

TABLE 3

| AMOUNT OF | | SENSORY |
|---|---|---|
| SQUALENE | ΔL* | EVALUATION |
| ADHERED(μg) | (θ) | RESULT |
| 27 | 0.09 | 3 |
| 30 | 0.09 | 3 |
| 50 | 0.54 | 2 |
| 78 | 0.99 | 1 |

It has been found as shown in Table 3 above that in a display device equipped with an oil-repellent coating, the amount of squalene adhered to the surface after transferring the artificial fingerprint liquid (assuming that a fingerprint is adhered) is less than 40 μg, resulting in 0.1 or less of ΔL*(θ) after the wiping operation and indicating excellent fingerprint resistance. In a display device equipped with a lipophilic coating, in which the angular dependence of ΔL*(θ) at a light incidence angle of −70° does not indicate a positive peak outside the specular reflection region, fingerprint components are fit even when adhered to lipophilic surfaces, and thus ΔL*(θ) is not affected by the amount of squalene adhered, and it has excellent fingerprint resistance (for example, even when the amount of squalene adhered exceeds 100 μg, ΔL*(θ) is −0.09).

As described above, it is found that the fingerprint resistance evaluation method of the present invention is an excellent evaluation method that can also be applied to in-vehicle display devices. The present invention is not limited to the above embodiments, and can be modified as appropriate without departing from the spirit.

This application claims priority based on Japanese Patent Application No. 2022-18975 filed on Feb. 9, 2022, Japanese Patent Application No. 2022-18976 filed on Feb. 9, 2022, Japanese Patent Application No. 2022-18977 filed on Feb. 9, 2022, Japanese Patent Application No. 2023-17102 filed on Feb. 7, 2023, Japanese Patent Application No. 2023-17104 filed on Feb. 7, 2023, and Japanese Patent Application No. 2023-17105 filed on Feb. 7, 2023, and all of those disclosures are incorporated herein.

### REFERENCE SIGNS LIST

1 LIGHT SOURCE
2 LIGHT-TRANSMITTING OBJECT
3 DISPLAY DEVICE
N NORMAL

1. A method for evaluating fingerprint resistance of a surface of an object, comprising:
using a measured value difference ΔL*(θ) between a portion to which an artificial fingerprint liquid is transferred and once wiped off, and a portion to which an artificial fingerprint liquid is not transferred on a surface of the object, obtained from formula (1) below with a variable angle colorimeter:
$$Δ L * ( θ ) = L * of wipping portion after transfer of artificial fingerprint liquid - L * of artificial fingerprint liquid non - transfer portion \qquad Formula ( 1 )$$
wherein a light incidence angle is −70° with respect to a normal to a surface of the object, and a measurement angle is −5° with respect to a normal to a surface of the object.

2. The evaluation method according to claim 1, wherein a method of transferring an artificial fingerprint liquid is a method including adhering the artificial fingerprint liquid to a base material for transfer by a spin coating method to prepare a transfer foil with a haze value of 7±2%, pressing a pseudo finger against the transfer foil with a load of 60 N, and then pressing the pseudo finger against a surface of the object for 2 seconds with a load of 60 N.

3. The evaluation method according to claim 1, comprising further using an amount of squalene adhered to a surface of the object when evaluating fingerprint resistance of the surface of the object.

4. A laminate comprising: a surface having a measured value difference ΔL*(θ) between a portion to which an artificial fingerprint liquid is transferred and once wiped off, and a portion to which an artificial fingerprint liquid is not transferred, obtained from formula (1) below with a variable angle colorimeter, of 0.1 or less,
$$Δ L * ( θ ) = L * of wipping portion after transfer of artificial fingerprint liquid - L * of artificial fingerprint liquid non - transfer portion \qquad Formula ( 1 )$$
wherein a light incidence angle is −70° with respect to a normal to a surface of a measurement object, and a measurement angle is −5° with respect to a normal to the surface of the measurement object.

5. The laminate according to claim 4, comprising a base material, a predetermined layer disposed on the base material, and an outermost layer disposed on the predetermined layer, wherein
the predetermined layer includes a first predetermined layer on a side of the base material and a second predetermined layer on a side of the outermost layer, and
a refractive index of the first predetermined layer is 2.00 or less.

6. The laminate according to claim 4, comprising a base material, a predetermined layer disposed on the base material, and an outermost layer disposed on the predetermined layer, wherein
the predetermined layer includes a first predetermined layer on a side of the base material and a second predetermined layer on a side of the outermost layer, and
a refractive

7. The laminate according to claim 4, wherein
on the surface of the laminate, angular dependence of ΔL*(θ) at the light incidence angle of −70° indicates a negative peak in a specular reflection region and a positive peak at an angle other than the specular reflection region, and
an amount of squalene adhered on the surface of the laminate after the transfer of the artificial fingerprint liquid and before wiping is less than 40 μg.

8. The laminate according to claim 4, wherein on the surface of the laminate, angular dependence of ΔL*(θ) at the light incidence angle of −70° does not indicate a positive peak at angles other than a specular reflection region.

9. The laminate according to claim 8, wherein an outermost layer is disposed on a second predetermined layer, and a distance from the surface of the outermost layer to the second predetermined layer is 60 nm or less.

10. The laminate according to claim 4, wherein a method of transferring the artificial fingerprint liquid is a method including adhering the artificial fingerprint liquid to a base material for transfer by a spin coating method to prepare a transfer foil with a haze value of 7±2%, pressing a pseudo finger against the transfer foil with a load of 60 N, and pressing the pseudo finger against the surface of the laminate for 2 seconds with a load of 60 N.

11. A display device comprising: the laminate according to claim 4.

12. A method for producing a laminate, wherein the laminate is produced so that on a surface of the laminate, a measured value difference ΔL*(θ) between a portion to which an artificial fingerprint liquid is transferred and once wiped off, and a portion to which an artificial fingerprint liquid is not transferred, obtained from formula (1) below with a variable angle colorimeter is 0.1 or less,
$$Δ L * ( θ ) = L * of wipping portion after transfer of artificial fingerprint liquid - L * of artificial fingerprint liquid non - transfer portion , \qquad Formula ( 1 )$$
a light incidence angle is −70° with respect to a normal to a surface of a measurement object, and a measurement angle is −5° with respect to a normal to the surface of the measurement object.

13. The evaluation method according to claim 2, comprising further using an amount of squalene adhered to a surface of the object when evaluating fingerprint resistance of the surface of the object.

14. The laminate according to claim 5, comprising a base material, a predetermined layer disposed on the base material, and an outermost layer disposed on the predetermined layer, wherein
the predetermined layer includes a first predetermined layer on a side of the base material and a second predetermined layer on a side of the outermost layer, and
a refractive index of the second predetermined layer is 1.43 or more and 1.49 or less.

15. The laminate according to claim 5, wherein
on the surface of the laminate, angular dependence of ΔL*(θ) at the light incidence angle of −70° indicates a negative peak in a specular reflection region and a positive peak at an angle other than the specular reflection region, and
an amount of squalene adhered on the surface of the laminate after the transfer of the artificial fingerprint liquid and before wiping is less than 40 μg.

16. The laminate according to claim 6, wherein
on the surface of the laminate, angular dependence of ΔL*(θ) at the light incidence angle of −70° indicates a negative peak in a specular reflection region and a positive peak at an angle other than the specular reflection region, and
an amount of squalene adhered on the surface of the laminate after the transfer of the artificial fingerprint liquid and before wiping is less than 40 μg.

17. The laminate according to claim 5, wherein on the surface of the laminate, angular dependence of ΔL*(θ) at the light incidence angle of −70° does not indicate a positive peak at angles other than a specular reflection region.

18. The laminate according to claim 6, wherein on the surface of the laminate, angular dependence of ΔL*(θ) at the light incidence angle of −70° does not indicate a positive peak at angles other than a specular reflection region.

19. The laminate according to claim 17, wherein an outermost layer is disposed on a second predetermined layer, and a distance from the surface of the outermost layer to the second predetermined layer is 60 nm or less.

20. The laminate according to claim 18, wherein an outermost layer is disposed on a second predetermined layer, and a distance from the surface of the outermost layer to the second predetermined layer is 60 nm or less.
